(19) United States
(12) Patent Application Publication
(10) Pub. No.: US 2024/0394091 A1
(43) Pub. Date: Nov. 28, 2024

(54) SYSTEM AND METHODS FOR OPTIMIZED EXECUTION LATENCY FOR SERVERLESS DIRECTED ACYCLIC GRAPHS

(71) Applicants: Sameh Elnikety, Redmond, WA (US); Purdue Research Foundation, West Lafayette, IN (US)

(72) Inventors: Somali Chaterji, West Lafayette, IN (US); Saurabh Bagchi, West Lafayette, IN (US); Ashraf Mahgoub, West Lafayette, IN (US); Sameh Elnikety, Redmond, WA (US)

(73) Assignee: Purdue Research Foundation, West Lafayette, IN (US)

(21) Appl. No.: 18/676,412

(22) Filed: May 28, 2024

Related U.S. Application Data
(60) Provisional application No. 63/469,336, filed on May 26, 2023.
(60) Provisional application No. 63/469,334, filed on May 26, 2023.

(51) Int. Cl. G06F 9/455

(52) U.S. Cl. CPC G06F 9/45558

(57) ABSTRACT

A system may receive a directed acyclic graphic (DAG) for an application. The system may profile the DAG with a plurality of computer resource allocations to generate an end-to-end (E2E) latency model. The system may generate, based on the E2E latency model, an execution plan comprising optimized computer resource allocations and timing information. The system may cause a computing infrastructure to execute a function in a first stage of the DAG model on a first virtual machine right sized according to the execution plan. The system may cause the computing infrastructure to initialize, at a time determined specified by the execution plan, a second virtual machine for a function in a second stage in the DAG model. The system may cause the FaaS infrastructure to execute the function in the second stage on the second virtual machine after completion of the function in the first stage.

### CROSS REFERENCE TO RELATED APPLICATIONS

This application claims the benefit of U.S. Provisional Application No. 63/469,336 filed May 26, 2023 and U.S. Provisional Application No. 63/469,334 filed May 26, 2023, the entireties of which are incorporated by reference herein.

### GOVERNMENT RIGHTS

This invention was made with government support under CNS2146449 awarded by the National Science Foundation and under Al123037 awarded by the National Institutes of Health. The government has certain rights in the invention.

### TECHNICAL FIELD

This disclosure relates to serverless infrastructure and, in particular, to computer resource optimization.

### BACKGROUND

Serverless computing (a.k.a., function as a service (FaaS)) has emerged as an attractive model for running cloud software for both providers and tenants. Recently, serverless environments are becoming increasingly popular for video processing, machine learning, and linear algebra applications. The requirements of these applications can vary from latency strict (e.g., Video Analytics for Amber Alert responders to latency-tolerant but cost-sensitive (e.g., Training ML models). The workflow of serverless pipelines is usually represented as a directed acyclic graph (DAG) in which nodes represent serverless functions and edges represent data dependencies between them.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a system.

FIG. 2 illustrates an example diagram of logic for a system.

FIG. 3 illustrates an example of pseudo-code for a Best-First algorithm to identify the best virtual machine (VM) sizes for functions in a directed acyclic graph (DAG) given a user-defined latency objective.

FIG. 4 illustrates an example of separate VMs having workers before and after bundling.

FIG. 5 illustrates the impact of different pre-warming delays on end-to-end (E2E) latency and utilization.

FIG. 6 illustrates a second example of a system.

### DETAILED DESCRIPTION

Serverless platforms experience high performance variability due to three primary reasons, among others, —some function invocations have cold starts, skew in the execution time of various functions due to different content the functions operate on, and skew in the execution time due to variability in infrastructure resources (such as, network bandwidth for an allocated VM). Because of this variance in performance, predicting the mean (or median) execution time of individual functions is not sufficient to meet percentile specific latency requirements (e.g., P95) for serverless DAGs.

The system and methods described herein provide a technique for performance modeling of serverless DAGs to estimate the end-to-end (E2E) execution time (synonymously, E2E latency). The modeling are leveraged to provide system optimizations such as allocating resources to each function to reduce E2E latency, while keeping $ costs low and utilization high.

Various experimentation were conducted to derive insights about serverless DAGs from analysis of production traces at a global FaaS provider and this lead to the performance model and the design features described herein. First, we observe the inherent performance variability in serverless DAGs and therefore represent the latency of a single function, as well as that of the entire DAG, as a distribution rather than a single value. For example, the execution times for the top-5 most frequently invoked DAG based applications executed by a major FaaS provider was measured. The execution times of invocations of the same DAG varies significantly, and the P95 latency is 80× of the P25 latency, averaged over the 5 applications. Thus, our performance model profiles the latency distribution for each function in the DAG and builds a performance model to also capture the impact of varying the resource allocation to that function on its latency distribution. Afterward, we estimate the DAG E2E latency distribution by applying a series of two statistical combination operations, convolution and max, respectively, for in-series and in-parallel functions. Moreover, we observe it is essential to consider the correlation between the workers across stages and within stages to accurately estimate the joint distributions. Our performance model does not require expensive profiling, as is needed for the leading technique, Bayesian Optimization.

We then use the performance modeling technique to design three optimizations for serverless DAGs. (1) Right-sizing: Finding the best resource configurations for each function to meet an E2E latency objective (e.g., 95-th percentile latency <X sec) with the minimum cost. (2) Bundling: Identifying stages where combining multiple parallel instances of a function together to be executed on one VM will be beneficial. The benefit arises when there is computation skew among the parallel workers caused by different content inputs. (3) Right pre-warming:

The virtual machines to execute the functions in the DAG are prewarmed just enough ahead of time so that cold starts can be avoided, while keeping provider-side utilization of resources high. With these three optimizations, the system and methods described herein accurately meets latency SLOs while reducing execution cost.

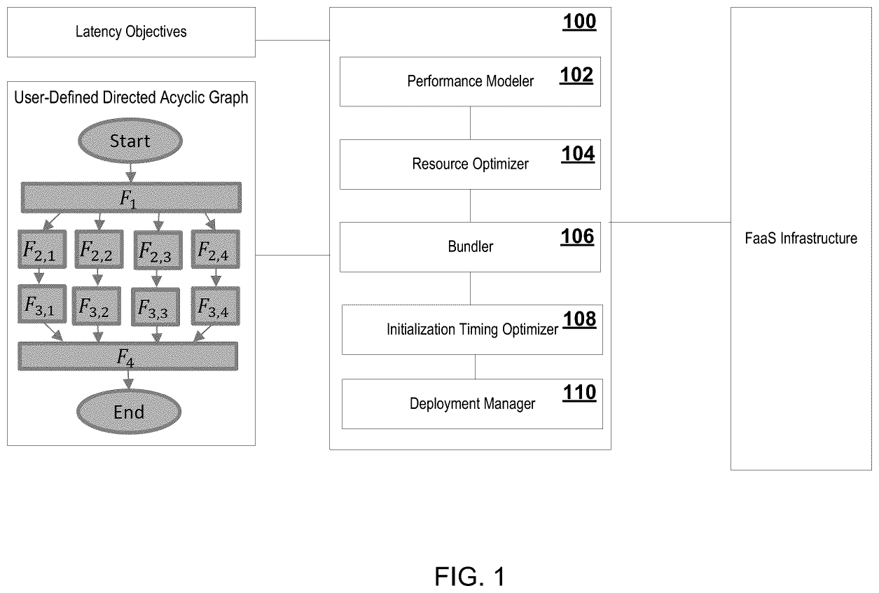

FIG. 1 illustrates an example of a system. The system may include a performance modeler 102, a resource optimizer 104, a bundler 106, an initialization timing optimizer 108, and a deployment manager 110. The system may be in communication with a FaaS infrastructure.

The FaaS infrastructure may be include services for developing, running, and managing application functionalities under the FaaS model. In the FaaS model, customers execute code in the cloud, while a cloud service provider hosts and manages the back-end operation. Customers are responsible only for their own data and the functions they perform. The FaaS model may be considered “serverless” from because the cloud service provider manages the cloud infrastructure, platform, operating system, and software applications-all of which may be opaque to the user.

“Serverless computing” is something of a misnomer, however. Even though FaaS users do not manage or even see the hardware, the FaaS model does run on servers. The hardware is owned, operated, and managed by the CSP, so customers can take full advantage of the functionality on demand, without purchasing or maintaining their own servers. Thus, the amount of computer resources provided to the allocated to functions executing on the FaaS infrastructure structure may be controlled or influenced through an application programming interface or other backend interface which allows for the development, deployment, and management of functions are executable in the FaaS infrastructure. The term computer resource, as described herein, refers to VM memory size, VM CPU core count, VM network bandwidth, VM storage size, or any other memory, processing, or networking resource made configurable for allocating to a VM by a FaaS infrastructure.

The terms pre-warming and initialization are herein used interchangeably when discussing the computing actions that must occur before a serverless function can be executed. Such initialization includes most significantly (from a time standpoint) loading all the libraries that the function has dependencies on (I.e., the serverless function needs to call functions from these libraries). Alternatively or in addition, the initialization may include waking up the virtual machine from a sleeping or standby state. In some examples, the initialization may include causing a thread or process in the virtual machine to wake up from a sleeping or standby state. Alternatively or in addition, the initialization may include loading the function, or dependencies of the function, into memory.

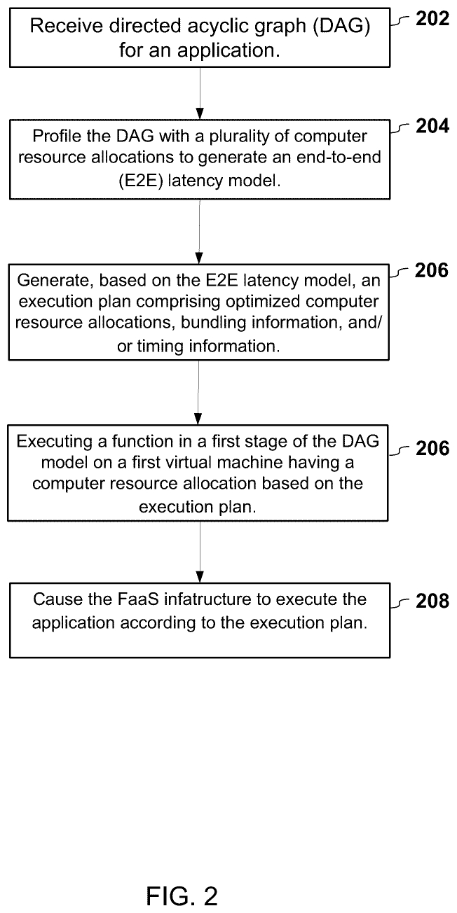

FIG. 2 illustrates an example diagram of logic for the system 100. The system may receive a Directed Acyclic Graph (DAG). A DAG is a data which specifies a chain of two or more serverless function stages that execute in-series. A stage consists of one or more parallel invocations (a.k.a. instances) of the same serverless function. DAG depth is the number of stages in the DAG. DAG width is the max number of parallel worker functions (a.k.a. fanout degree) across all stages in the DAG. A DAG with width=1 means it is a chain of sequential function invocations, whereas a DAG with width >1 means it has at least one parallel stage. Finally, we define skew in a parallel stage as the ratio of the execution times of the slowest to the fastest worker function.

The system may profile the DAG with a plurality of computer resource allocations to generate an end-to-end (E2E) latency model (204). To create the E2E latency model, the system may generate distributions for each function in the DAG model.

Modeling latency as a distribution rather than a single statistic. To estimate the E2E latency and cost of a serverless DAG, it is essential to model the latency of each component as a distribution. For example, the latency of the image classification function (Classify-Frame) a the Video Analytics DAG can vary by up to 2× when processing different frames, even when keeping the VM-size fixed to 1 GB. Although similar performance variability can be observed in server-centric platforms, our model is geared to serverless platforms due to their ability to scale resources according to demand virtually unboundedly and hence showing negligible queuing times. Now consider a simple stage of two Classify-Frame functions running in parallel. Let X and Y be random variables representing the latency of each. The E2E latency of the two workers combined is given as P(Z≤z)=P(X≤z,Y≤z), which depends on the slowest of the two and hence knowing their median or even their P99 latencies is not sufficient to estimate their combined CDF. In fact, we need the entire distribution of both components to estimate the E2E latency distribution. Moreover, simply using statistical tail bounds is not suitable for our purpose. For example, Chebyshev's inequality uses the mean and variance to establish a loose tail bound and it is not known how to combine tail bounds for in-series and in-parallel functions with their correlations.

Impact of Correlation. To accurately estimate the combined latency distribution for in-series or in-parallel functions, we need to capture the correlation between their execution times. Ignoring correlation by assuming statistical independence leads to over-estimating the combined distribution for in-parallel functions, while it leads to under-estimation for in-series functions. In our evaluation, we give a quantitative evidence of these effects (§ 5.4.2) and show that a performance model that is distribution-agnostic (e.g., SONIC [38]) or correlation-agnostic (e.g., [25]) fails to provide accurate E2E latency estimates.

### Modeling E2E Latency Distribution

Modeling Functions Runtimes. We represent the runtime of a function as the sum of its initialization and execution times. Since both phases have a high variance, we represent them as separate distributions. This separation allows us to estimate the gains from each optimization. Allocating the right resources and bundling mainly impacts the execution times, whereas pre-warming reduces initialization times.

Combining Latency Distributions. Given a latency distribution for every function, the system applies a series of statistical operations to estimate the DAG E2E latency distribution.

For two in-series functions with latency distributions represented as random variables X and Y, we use Convolution to estimate their combined distribution as: P(Z=z)=Σ_{∀k} P(X=k,Y=z−k). If X and Y are independent, we simplify the computation: P(Z=z)=Σ_{∀k} P(X=k)·P(Y=z−k). The latter is simpler to estimate since it only requires the marginal distributions of the two components, which can be profiled separately, rather than jointly.

On the other hand, if the two functions execute in parallel, then their combined latency distribution will be defined by the max of the two. Therefore, we use the Max operation to combine their CDFs as follows: P(Z≤z)=P(X≤z,Y≤z). Similar to the Convolution operation, a simpler form can be used when X and Y are independent: P(Z≤z)=P(X≤z)·P(Y≤z), which uses the marginal CDFs of the two components, rather than their joint CDF.

Handling Correlation Among Functions. We consider two types of statistical correlation in the DAG: in-series and in parallel correlation. For example, in a Video Analytics application may have high correlation between Pre-process and Classify stages, and also high correlation between parallel Extract workers or parallel Classify workers. By analyzing the correlation between the stages as well as the correlation between the parallel workers in the same stage, the system identifies both types of correlation. We consider a Pearson correlation coefficient value greater than an experimental parameter θ, as an indication of correlation, and decide to apply the independent or dependent formulation for the CONV or the MAX operation accordingly. In our experiments, we find that the performance of ORION is relatively insensitive for θ ∈ (0.2,0.5) and we run all the experiments with θ=0.4.

To determine the length of correlation chains (pairwise, etc.), the system uses conditional entropy measurements of the execution time and compares the reduction in entropy by including additional terms. Thus, if marginal entropy of stage Y is H(Y)>>H(Y|Xᵢ)≈H(Y|Xᵢ,Xⱼ)≈H(Y|Xᵢ,Xⱼ, . . . ,Xₛ) where Xᵢ denotes the random variable of worker i's execution time, then the system infers correlation across stages are at most pairwise. We find that correlation in all our application DAGs across stages are at-most pairwise. Our formulation can handle any degree of correlation, not just pairwise. Only the amount of profiling data needed will increase with higher degrees of correlation.

In case of high correlation between N parallel workers in the same stage, MAX operation can be expanded by the chainrule: P(Z≤z)=P(X₁≤z)·P(X₂≤z|X₁≤z) . . . P(X_{N}≤z|X₁≤z,X₂≤z, . . . ,X_{N}−1≤z), which is further simplified in case of pair-wise correlations by only conditioning on one worker, hence all conditional terms reduce to P(Xᵢ≤z|Xᵢ−1≤z). Since all components within a stage are identical, we estimate the above equation as follows:

$$P ( Z \leq z ) = P ( {X}_{i} \leq z ) . {[ P ( {X}_{k} \leq z \vert {X}_{i} \leq z ) ]}^{n - 1} , k \neq i \qquad ( 1 )$$

Therefore, we use two distributions to model the MAX for any number of parallel components—the marginal distribution and the conditional distribution. In practice, all individual components are used to estimate the marginal distribution and all pairs of components are used to estimate the conditional distribution, as all marginal distributions are identical and so are all conditional distributions.

When generating the latency distributions for the E2E performance model, the system may allocate resources and measure the latency of executing each function in the DAG model with the different resource configurations. Once the E2E performance model is generated for the different resource configurations, intermediate configurations may be interpolated for optimization (as described below).

After the E2E latency model is create, the system may generate, based on the E2E latency model, an execution plan comprising optimized computer resource allocations, bunding information, and/or timing information (206).

### Allocating Right Resources

The computer resource allocations in the execution plan may specify the amount or types of computer resources to allocate to functions in the DAG. Example of the computer resource allocations include, but are not limited to, storage size, CPU cores, memory, network bandwidth, and other types of computer resource allocation made available by the FaaS provider. The following is an examples primarily use VM-storage size as an example of a computer resource allocation, but others may be optimized using the system and methods described herein.

The target of this optimization is to assign the right resources for each function in the DAG so that the entire DAG meets a latency objective with minimum cost. Normally, the user picks the VM-size for each function, and the VM-size controls the amount of allocated CPU, memory, and network bandwidth capacities. What makes this problem challenging is twofold—the scaling of multiple orthogonal resources is coupled together and the scaling of different resources is not linear. As an example, the Classify-Frame function in the Video Analytics DAG has a small memory footprint (540 MB). However, increasing its VM-size reduces latency until 1,792 MB as that size comes with a full vCPU. Larger sizes come with a fraction of a second core up to six cores, which this function cannot utilize. Thus, allocating larger sizes increases cost without any benefit to latency.

The first step in this optimization is to map a given configuration candidate (i.e., a vector of VM-sizes, with one entry per stage) to the corresponding latency distribution. To achieve this, we build a per-function performance model that maps VM-sizes to latency distributions. Next, we combine these distributions to estimate the E2E latency distribution.

Per-function Performance Model. For each function in the DAG, we collect the latency distributions for the following VM sizes: min (the minimum VM size needed for this function to execute), 1,024 MB, 1,792 MB, and max. We pick 1,024 MB as it is the point of network-bandwidth saturation (increasing VM-size beyond it does not provide more bandwidth), and 1,792 MB as it comes with one full CPU core. Hence, this initial profiling divides the configuration space into 3 regions: [Min, 1024), [1024, 1792), and [1792, Max].

In order to estimate latency distribution for intermediate VM-sizes, we use percentile-wise linear interpolation. For example, the P50 for 1408 MB is interpolated as the average between the P50 for 1,024 MB, and the P50 for 1,792 MB settings. This generates a prior distribution for these intermediate VM-size settings. To verify the estimation accuracy in a region, the system collects a few test points using the midpoint VM-size in that region to measure its actual CDF (i.e., the posterior distribution) and compares it with the prior distribution. If the error between the prior and posterior CDFs is high, the system collects more data for the region midpoint and adds it to its profiling data. In summary, this approach divides the space of a potentially non-linear function into a set of approximately linear functions, and hence, more complex functions get divided into more regions, with a profiling cost overhead. In practice, we find that 5 to 6 regions accurately model the latency distributions for all functions in our applications.

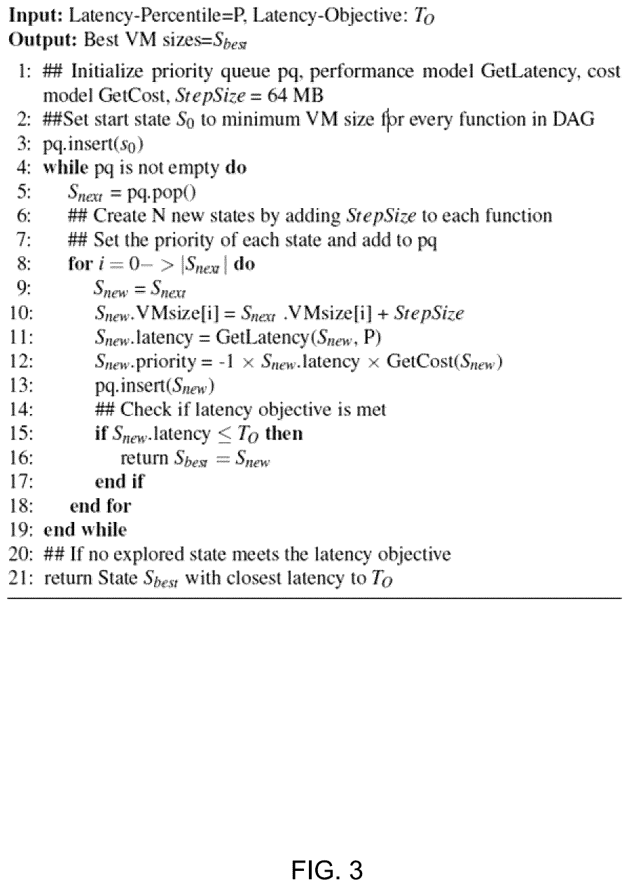

Optimizing Resources for a Latency Objective. FIG. 3 illustrates an example of pseudo-code for a Best-First algorithm to identify the best VM sizes for functions in a DAG given a user-defined latency objective. Since the performance model estimates the E2E latency distribution of the DAG, we can use it to choose a configuration (i.e., the set of VM sizes) to execute a DAG to meet a user-specified latency objective while reducing $ cost. We search for the configurations using a heuristic based on Best-First Search (BFS).

The algorithm starts by creating a priority queue, in which all the new states are added. A state here represents a vector of VM sizes, one for each stage. Each new state expands the current state in one dimension (with a step-size of 64 MB) and the start state S0 has the minimum VM size for every function. The priority is set to be the difference between the target latency and each state's estimated latency divided by the $ cost of the new state (lower value means higher priority). Our chosen heuristic is suitable for our problem because latency is a monotonically non-increasing function of resources allocated to a function. The worst-case complexity of BFS is O(n*log (n)) where n is the number of states.

### Bundling Parallel Invocations

In some examples, the execution plan may include bundling information that specifies how to bundle multiple functions in a stage of the DAG. Stragglers can dominate an application's E2E latency. Here we show how to bundle multiple parallel workers in one stage within a larger VM, rather than the current state-of-practice of executing each in a separate VM. This promotes better resource sharing thus mitigating skew.

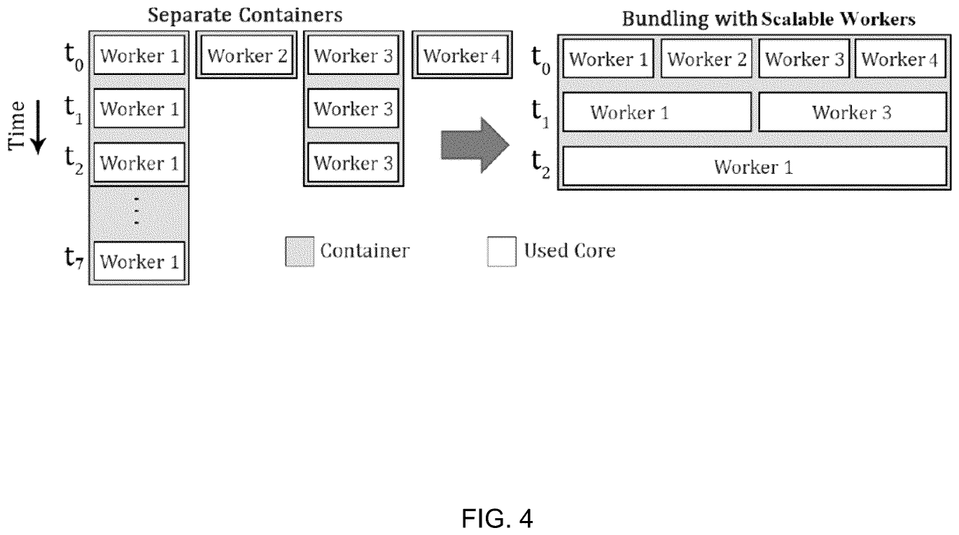

To understand how bundling works, consider the example shown in FIG. 4. FIG. 4 illustrates an example of separate VMs having workers before and after bundling. Specifically, the load for workers #2 and #4 is low and both require only one time step of execution. In contrast, the load for workers #1 and #3 is higher and requires 7 and 3 time steps of execution, respectively. If we execute each worker on a separate VM say with 1 core each, the E2E latency is dominated by the slowest worker and the entire stage will take 7 time steps. However, if we bundle the workers together in a single VM with 4 cores, the E2E latency reduces to 3 time steps only. This is because the straggler workers get access to more resources when the lightly loaded workers finish their execution. Notice that the cost remains the same in both cases because they consume 1 core×12 time steps or 4 cores×3 time steps for the entire stage.

We make a few observations about the applicability of bundling. First, bundling is useful in reducing the latency if the execution skew is due to load imbalance, which arises from processing bigger partitions of data, or inputs that require more computation. We detect load imbalances due to content by subtracting latency CDF #1 from #2: (#1) When the function is executed multiple times with the same input. (#2) When the function is executed multiple times with different inputs. Moreover, the higher the correlation between workers, the lower is the gap between their execution times and hence the lower is the benefit from bundling.

Second, for bundling to be useful, the function has to be scalable to benefit from the additional resources. We identify a function's scalability using our performance model to estimate the impact on the function's latency CDF when given more resources. We benefit from the fact that the community has developed many highly scalable libraries, which are widely used in serverless applications.

Third, our example in FIG. 4 assumes there will be no contention between bundled workers. However, in practice we find that this contention can be high, especially for network bound or IO-bound functions, as these resources do not scale linearly with the VM size. For example, all VM sizes in AWS Lambda get the same disk space of 512 MB and network bandwidth scales only for VM sizes until 1,024 MB.

Based on these three requirements, the system identifies the best bundle size in two steps. First, the system identifies functions that experience execution skew and are scalable using the performance model. Second, the system searches the space of bundle sizes through multiplicative increase (i.e., bundle sizes of 1, 2, 4, etc.). At each step, the system collects very few profiling runs (we use 10 in experimentation) to capture contention. The search terminates when bundling more workers causes contention and hence increases the E2E latency. As a side note, the system does not currently bundle functions in different stages as they may have very different resource requirements making it counterproductive to come up with one VM size that fits multiple stages. The system strives to spread stragglers across different VMs so that each straggler has excess resources to speed up its execution. Since skew often shows up with temporal locality, we spread the parallel functions among the available bundles in a round-robin manner. For example, for a Video Analytics application, load typically varies gradually across consecutive frames.

### Pre-Warming to Mitigate Cold Starts

The system may determine optimum delay times, expressed from the start of the application, to begin virtual machine initialization for each stage of the DAG model. In doing so, the system may mitigate cold starts, leveraging the DAG structure of the application. We describe how to identify when to start pre-warming the virtual machines for each stage in the DAG, in order to balance the E2E latency and the utilization of the computing resources. This step is performed after we perform the previous two optimizations, Right-sizing and Bundling.

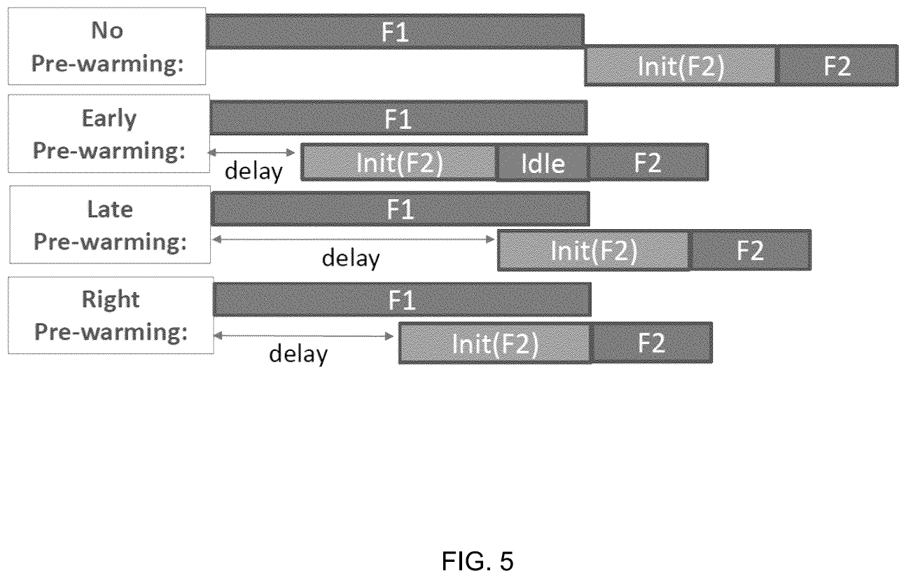

FIG. 5 illustrates the impact of different pre-warming delays on E2E latency and utilization. At the extreme, a delay of zero for every stage minimizes the E2E latency but also minimizes the utilization. The other extreme is no pre-warming at all, which is the state-of-practice.

First, we define pre-warming delay for a stage S as the time elapsed between the start of the DAG execution and the beginning of initialization of the virtual machines for that stage. For a given DAG of N stages, we want to select a vector \vec{d}=[d₁,d₂, . . . d_{N}] representing the pre-warming delays for each stage in the DAG. For the first stage in the DAG, we have the degenerate case and set its delay (d₁) to zero since prewarming it requires predicting when the DAG will be invoked, which is challenging in the general case. The optimal delay vector, given a performance model P, is defined as follows:

$${\overline{d}}^{*} = {arg min}_{\vert \vec{d}} E 2 E - Latency ( P , \vec{d} ) \qquad Eq . 1$$

$$subject to Utilization ( P , \vec{d} ) \geq Target Utilization$$

The selected vector is the one that minimizes the DAG E2E latency while achieving the target resource utilization as set (and dynamically adjusted) by the FaaS provider. Both the utilization and the E2E latency are estimated by our performance model P. The metric Utilization (P,d̅) is estimated as:

$$\frac{BusyTime ( C )}{BusyTime ( C ) + IdleTime ( C )} \qquad Eq . 2$$

BusyTime (C) includes both initialization and execution times while IdleTime (C) is the time between when the initialization completes to when the function starts executing. We again use Best-First Search (BFS) to select vector \vec{d}*as follows. We start by setting all values of dᵢ=0, and in each iteration, we add a delta (100 ms) to the delay factor di that yields the best improvement in utilization over the current state without increasing the E2E latency. The algorithm terminates when adding delta to any delay factor does not improve utilization but increases E2E latency.

Referring back to FIG. 2, once the execution plan has been identified, the system may cause the FaaS infrastructure to execute the application according to the DAG and the execution plan (208).

The system may cause the FaaS infracuture to execute a function in a first stage of the DAG model on a first virtual machine. The first virtual machine may have a computer resource allocation based on the execution plan. The computer resource allocation may occur prior to execution of the application or during execution of the application. The system may cause the FaaS to initialize, at time specified by the execution plan, a second virtual machine for a function in a second stage in the DAG model. The second virtual machine may have computer resources allocated according to one of the optimized computer resource allocations in the execution plan. The computer resource allocation may occur prior to execution of the application or during execution of the application. The system may cause the FaaS to execute the function in the second stage on the second virtual machine after completion of the function in the first stage.

The logic illustrated in the flow diagrams may include additional, different, or fewer operations than illustrated. The operations illustrated may be performed in an order different than illustrated.

The system 100 may be implemented with additional, different, or fewer components than illustrated. Each component may include additional, different, or fewer components.

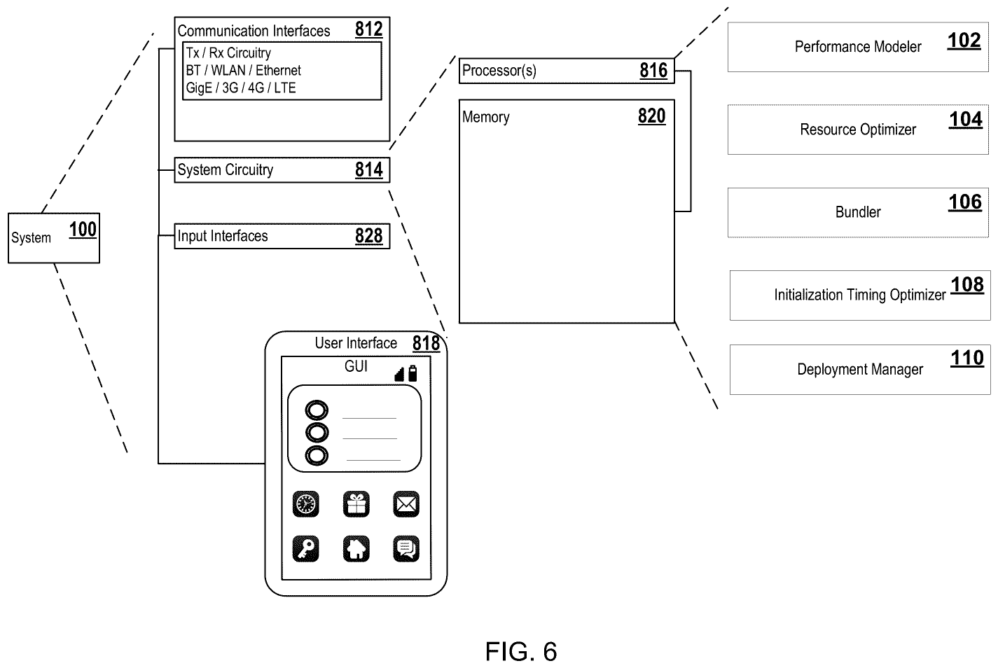

FIG. 6 illustrates a second example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations the Performance Modeler 102, the resource optimizer 104, the bundler 106, the initialization timing optimizer 108, and the deployment manager 110, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the IP storage 110, the executable(s) 122, the input parameter(s) 114, runtime engine 116, the collaboration session 118, the security framework 122, the descriptor storage 128, the results storage 130, the cloud environment 102, and/or the system 100. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the IP storage 110, the executable(s) 122, the input parameter(s) 114, runtime engine 116, the collaboration session 118, the security framework 122, the descriptor storage 128, the results storage 130, the cloud environment 102, or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method, comprising:
receiving a directed acyclic graphic (DAG) for an application, the DAG comprising a plurality of stages arranged in a series, each stage comprising at least one function;
profiling the DAG with a plurality of computer resource allocations to generate an end-to-end (E2E) latency model;
generating, based on the E2E latency model, an execution plan comprising optimized computer resource allocations and timing information, the optimized computer resource allocations associated with functions in the DAG and the timing information associated with the stages in the DAG; and
cause an FaaS infrastructure to:
execute a function in a first stage of the DAG model on a first virtual machine, the first virtual machine having a computer resource allocation based on the execution plan;
initialize, a time determined specified by the execution plan, a second virtual machine for a function in a second stage in the DAG model, the second virtual machine having computer resources allocated according to one of the optimized computer resource allocations; and
execute the function in the second stage on the second virtual machine after completion of the function in the first stage.

2. The method of claim 1, wherein generating, based on the E2E latency model, the execution plan further comprises:
generating bundling information associating multiple functions in a stage with a computer resource allocation for a virtual machine that will execute all of the multiple functions of the stage in parallel.

3. The method of claim 2, further comprising:
executing, based on the bundling information, the multiple functions in the first stage in parallel.

4. The method of claim 1, wherein profiling the DAG with a plurality of computer resource allocations to generate an end-to-end (E2E) latency model comprises:
generating a plurality of latency distributions for each function in the DAG, the latency distributions representing initialization and execution time of each function in the DAG executed using the computer resource allocations, respectively; and
generating, based on the latency distributions for each function, an end-to-end latency model which models the end-to-end latency for executing the stages of the DAG model using the computer resource allocations.

5. The method of claim 3, wherein generating the plurality of latency distributions for each function in the DAG further comprises:
measuring the latency of executing each function in the DAG with each of the computer resource allocations.

6. The method of claim 1, wherein generating, based on the E2E latency model, the execution plan comprising optimized computer resource allocations and timing information further comprises:
determining, based on the E2E latency model, optimum delay times, expressed from the start of the application, to begin virtual machine initialization for each stage of the DAG, wherein the optimum delay times are the highest delay times possible without increasing E2E latency.

7. The method of claim 1, wherein before executing the function in the first stage of the DAG on the first virtual machine, the method further comprises:
allocating storage on the first virtual machine according to the VM size information in the execution plan.

8. A system, comprising:
A processor, the processor configured to
receive a directed acyclic graphic (DAG) for an application, the DAG comprising a plurality of stages arranged in a series, each stage comprising at least one function;
profile the DAG with a plurality of computer resource allocations to generate an end-to-end (E2E) latency model;
generate, based on the E2E latency model, an execution plan comprising optimized computer resource allocations and timing information, the optimized computer resource allocations associated with functions in the DAG and the timing information associated with the stages in the DAG; and
cause an FaaS infrastructure to:
execute a function in a first stage of the DAG model on a first virtual machine, the first virtual machine having a computer resource allocation based on the execution plan;
initialize, a time determined specified by the execution plan, a second virtual machine for a function in a second stage in the DAG model, the second virtual machine having computer resources allocated according to one of the optimized computer resource allocations; and
execute the function in the second stage on the second virtual machine after completion of the function in the first stage.

9. The system of claim 8, wherein to generate, based on the E2E latency model, the execution plan, the processor is further configured to:
generate bundling information associating multiple functions in a stage with a computer resource allocation for a virtual machine that will execute all of the multiple functions of the stage in parallel.

10. The system of claim 9, wherein the processor is further configured to:
execute, based on the bundling information, the multiple functions in the first stage in parallel.

11. The system of claim 8, wherein to profile the DAG with a plurality of computer resource allocations to generate an end-to-end (E2E) latency model, the processor is configured to:
generate a plurality of latency distributions for each function in the DAG, the latency distributions representing initialization and execution time of each function in the DAG executed using the computer resource allocations, respectively; and
generate, based on the latency distributions for each function, an end-to-end latency model which models the end-to-end latency for executing the stages of the DAG model using the computer resource allocations.

12. The system of claim 1, wherein to generate the plurality of latency distributions for each function in the DAG further, the processor is further configured to:
measure the latency of executing each function in the DAG with each of the computer resource allocations.

13. The system of claim 8, wherein to generate, based on the E2E latency model, the execution plan comprising optimized computer resource allocations and timing information the processor is further configured to:
determine, based on the E2E latency model, optimum delay times, expressed from the start of the application, to begin virtual machine initialization for each stage of the DAG, wherein the optimum delay times are the highest delay times possible without increasing E2E latency.

14. The system of claim 8, wherein before executing the function in the first stage of the DAG on the first virtual machine, the processor is further configured to:
allocate storage on the first virtual machine according to the VM size information in the execution plan.
